(19) United States
(12) Patent Application Publication
(10) Pub. No.: US 2004/0040846 A1
(43) Pub. Date: Mar. 4, 2004

(54) Sensor element

(76) Inventors: Detlef Heimann, Gerlingen (DE); Hans-Joerg Renz, Leinfelden-Echterdingen (DE); Ulrich Eisele, Stuttgart (DE); Lothar Diehl, Gerlingen (DE); Thomas Moser, Schwieberdingen (DE); Juergen Karle, Rutesheim (DE)

Correspondence Address: KENYON & KENYON, ONE BROADWAY, NEW YORK, NY, 10004, US

(21) Appl. No.: 10/332,337

(22) PCT Filed: May 2, 2002
(86) PCT No.: PCT/DE02/01583

(30) Foreign Application Priority Data
May 5, 2001 (DE) 101 21 889.3

(51) Int. Cl. G01N 27/26

(52) U.S. Cl. 204/426; 204/428; 29/592.1

(57) ABSTRACT

A sensor element (10) for determining a gas component, in particular for determining the oxygen concentration in exhaust gases of internal combustion engines, is described; a measurement gas space (41) is introduced into the sensor element (10), and at least one electrode (31, 32) is provided in the measurement gas space, which is connected to the gas outside the sensor element (10) via a gas inlet opening (43). A diffusion barrier (44) is provided between the gas inlet opening (43) and the electrode (31, 32). At least one spacer element (50, 51) is provided in at least some areas of the measurement gas space (41) and has a higher pore content than the diffusion barrier (44) or it allows access of the measurement gas to at least the areas of the electrode (31, 32) not covered by the spacer element (50, 51).

### BACKGROUND INFORMATION

The present invention relates to a sensor element for determining a gas component, in particular for determining the oxygen concentration in exhaust gases of internal combustion engines according to the preamble of the independent claims.

Such a sensor element is already described in German Patent Application 198 38 456 A1, for example. This sensor element, which is known as a broadband lambda probe by those skilled in the art, has a measurement gas space which is incorporated into the sensor element and is connected to the exhaust gas outside the sensor element via a gas inlet opening; a first and a second electrode are situated one opposite the other in this measurement gas space. A diffusion barrier having a porous material is provided between the electrodes and the gas inlet opening. The area between the two electrodes is designed as a cavity.

One disadvantage of such sensor elements is that the cavity between the two diametrically opposed electrodes may be compressed during the manufacturing process, thus having a negative effect on access of gas to the electrodes or suppressing it entirely. Furthermore, the first and second electrodes may come in contact, causing a short circuit and thus impairing sensor function.

German Patent Application 43 42 005 A1 also describes a sensor element having a measurement gas space which is incorporated into the sensor element and is connected to the exhaust gas outside the sensor element via a gas inlet opening and in which an electrode is situated. The measurement gas space here is filled completely, i.e., including the area of the electrode, with a diffusion barrier made of a porous material having a uniform porosity.

Since the measurement gas space in such a sensor element is filled up in the area of the electrode, this prevents compression of the measurement gas space during the manufacturing process. However, it is a disadvantage of these sensor elements that due to the diffusion barrier located in the area of the electrodes, the gas exchange between the areas of the electrode facing the gas inlet opening and the areas of the electrode facing away from the gas inlet opening is hindered, so that the load on the electrode is not uniform.

### ADVANTAGES OF THE INVENTION

The sensor element according to the present invention as characterized in the independent claims has the advantage that collapse of the measurement gas space in the manufacturing process is prevented by at least one spacer element in the measurement gas space, while at the same time ensuring adequate gas exchange between the various areas of an electrode situated in the measurement gas space.

To do so, the measurement gas space is filled in at least some areas with a porous material which has a higher pore content than a diffusion barrier situated between a gas inlet opening and the measurement gas space. In an alternative embodiment, some areas of the measurement gas space may have at least one spacer element which has a closed porosity or no porosity at all, for example, and which allows access to the areas of the electrode not covered by the spacer element. In another alternative, a spacer element is designed so that the magnitude of the diffusion flow of the measurement gas and/or a component of the measurement gas from the gas inlet opening to the electrode is limited essentially by the diffusion barrier.

Advantageous embodiments and refinements of the sensor element characterized in the independent claims are possible through the measures characterized in the dependent claims.

If the porosity of the spacer element is selected so that the pore content of the spacer element is at least 30% higher than the pore content of the diffusion barrier (pore contents given in vol %) and/or the pore content of the spacer element is 60 to 80 vol %, then an adequate gas exchange in the measurement gas space is ensured especially reliably. A short circuit between two electrodes situated in the measurement gas space may be prevented especially effectively if at least approximately all of the area between the two electrodes is filled up by the spacer element.

In another advantageous embodiment, additional spacer elements resembling supporting posts are provided in the measurement gas space and are, for example, uniformly distributed on the side of the measurement gas space facing away from the diffusion barrier. The spacer elements preferably cover a total of at most 50% of the area of the electrode situated in the measurement gas space. Such an arrangement of the spacer elements reliably ensures that the gas exchange in the measurement gas space will not be hindered by the spacer elements.

It is also especially advantageous if the spacer element contains a catalytically active material, e.g., platinum, thus ensuring that a thermodynamic equilibrium will be established among the constituents of the gas.

If two electrodes are provided in the measurement gas space and both are connected to the spacer element, then in another advantageous embodiment of the present invention, a material that insulates with respect to electron conduction is advantageously selected for the spacer element to prevent an unwanted electric connection between the two electrodes. If the spacer element contains an electron-conducting material such as catalytically active platinum, then the electron-conducting material must be insulated from at least one of the electrodes by an electrically insulating material in order to prevent a short circuit.

In a method according to the present invention for manufacturing the spacer element, the spacer element is formed by a paste in the unsintered state. The paste is applied to a green film, i.e., a solid electrolyte layer in the unsintered state, e.g., by a screen printing technique, and sintered, if necessary, after a lamination operation. The paste contains a ceramic powder and a pore-forming substance, where the average particle radius of the ceramic powder and the pore-forming substance differs by no more than 20%, and the volume content of the ceramic powder is approximately the same as that of the pore-forming substance in the paste. This achieves an optimum space-filling effect and a mutual support of the particles of the ceramic powder, so that it is possible to manufacture a spacer element having a high porosity. Glass carbon, theobromine, flame carbon and/or other carbon compounds having an average particle diameter in the range of 2 to 30 μm have proven suitable for the pore-forming substance.

### DRAWING

Exemplary embodiments of the present invention are illustrated in the drawing and explained in the following description.

FIG. 1 shows as the first exemplary embodiment a sensor element according to the present invention in a sectional diagram;

FIG. 2 shows a section of the first exemplary embodiment corresponding to sectional line II-II in FIG. 1;

FIG. 3 shows as the second exemplary embodiment the sensor element according to the present invention in a sectional diagram;

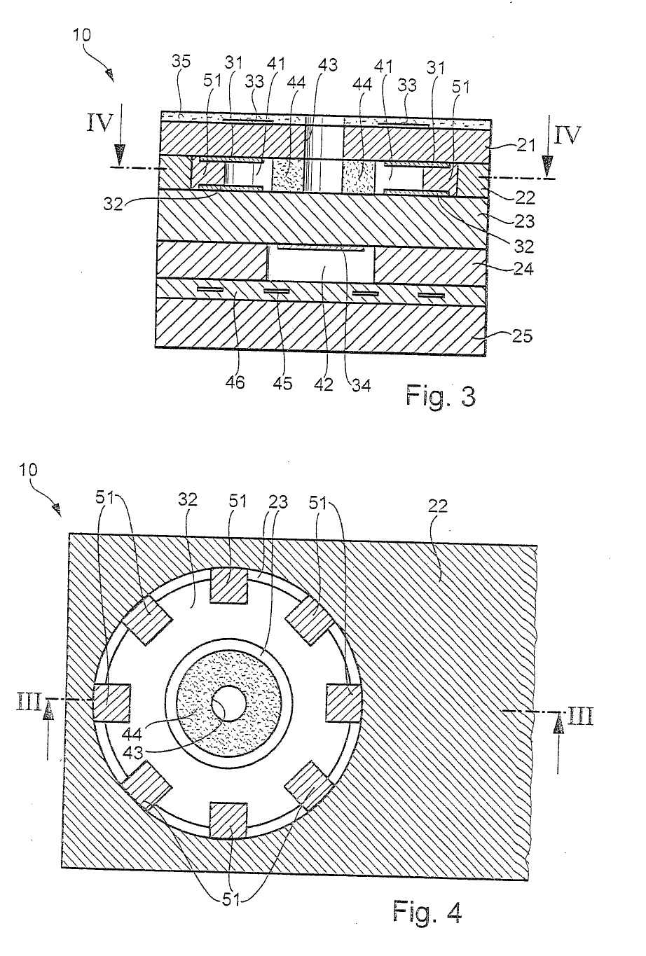

and FIG. 4 shows a section of the second exemplary embodiment corresponding to sectional line IV-IV in FIG. 3.

### DESCRIPTION OF THE EXEMPLARY EMBODIMENTS

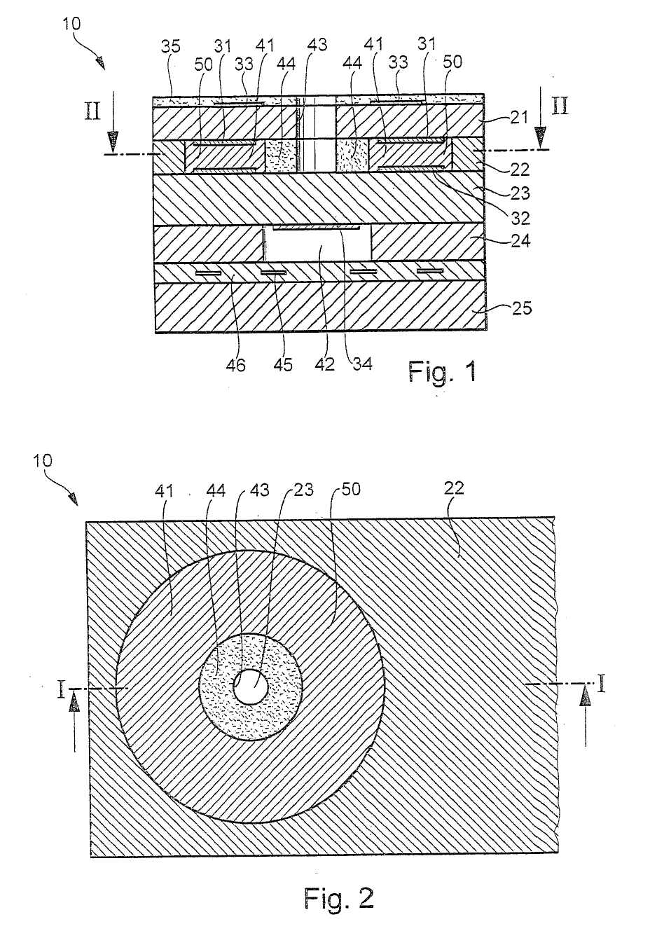

FIGS. 1 and 2 show as the first exemplary embodiment of the present invention a sensor element 10, which is used to detect a gas component, e.g., oxygen in the exhaust gas of an internal combustion engine. Sensor element 10 is constructed as a layered system having a first, second, third, fourth, and fifth solid electrolyte layer 21, 22, 23, 24, 25. A gas inlet opening 43 is incorporated into first and second solid electrolyte layers 21, 22. A measurement gas space 41 is provided in the second solid electrolyte layer and a diffusion barrier 44 is provided between measurement gas space 41 and gas inlet opening 43. The exhaust gas is able to pass through gas inlet opening 43 and diffusion barrier 44 to enter measurement gas space 41. Measurement gas space 41 is separated by third solid electrolyte layer 23 from a reference gas space 42, which is incorporated into fourth solid electrolyte layer 24, contains a reference gas and is connected to a reference atmosphere situated outside of sensor element 10, for example. Between fourth and fifth solid electrolyte layers 24 and 25 there is a heater 45 which is electrically insulated from the surrounding solid electrolyte layers 24, 25 by a heater insulation 46.

A first electrode 31 is applied to first solid electrolyte layer 21 in measurement gas space 41, forming a pumping cell together with a third electrode 33 applied to an outside surface of sensor element 10 and the area of first solid electrolyte layer 21 between first and third electrodes 31, 33. Third electrode 33 is coated with a porous protective layer 35. In measurement gas space 41, a second electrode 32 is applied to third solid electrolyte layer 23 on the side opposite first electrode 31 and forms a Nernst cell together with a fourth electrode 34 situated in reference gas space 42 and the area of third solid electrolyte layer 23 situated between second and fourth electrodes 32, 34.

To prevent measurement gas space 41 from being compressed in the manufacture of sensor element 10, thereby short-circuiting first and second electrodes 31, 32 or reducing the area of first and/or second electrodes 31, 32 accessible to the measurement gas, measurement gas space 1 is filled with a porous material which functions as spacer element 50. Spacer element 50 has a pore content of 60 to 85 vol %, preferably 70 vol %. The pore content of diffusion barrier 44, however, is lower than the pore content of spacer element 50, and is 20 to 80 vol %, preferably 50 vol %.

Sensor element 10 is manufactured in a known manner by applying the various function layers such as electrodes 31, 32, 33, 34, protective layer 35, diffusion barrier 44, and spacer element 50 in the form of pastes by screen printing, for example, to the various green films, i.e., the unsintered solid electrolyte layers. Then the printed green films are laminated together and sintered. The pastes may contain pore-forming substances such as glass carbon, theobromine, flame carbon, and/or other carbon compounds. The pore-forming substances burn up in sintering and leave behind a cavity.

A paste containing a ceramic powder and a powdered pore-forming substance with approximately equal volume amounts is used for spacer element 50. The average diameter of the particles of the ceramic powder and the pore-forming substance in the paste is also approximately the same, namely in the range from 2 μm to 30 μm, preferably 10 μm.

FIGS. 3 and 4 illustrate a second exemplary embodiment of the present invention which differs from the first exemplary embodiment in that eight spacer elements 51 like supporting posts are provided in measurement gas space 41, filling up only a partial area of measurement gas space 41 and not necessarily being porous. Spacer elements 51 are positioned at equal intervals on the side of measurement gas space 41 facing away from diffusion barrier 44 and have a rectangular cross section. Spacer elements 51 cover only approximately 20% of the area of first and second electrodes 31, 32, thus ensuring adequate access of the measurement gas to first and second electrodes 31, 32.

Spacer element 50, 51 of the first and second exemplary embodiments is preferably made of a material that does not conduct electrons such as Al₂O₃ or ZrO₂. For special applications, it may also be necessary for spacer element 50, 51 not to be ion conducting (Al₂O₃).

In an alternative instance of the first and second exemplary embodiments, spacer element 50, 51 has a catalytically active substance, preferably platinum. First and second electrodes 31 and 32 should be prevented from being connected electrically by the catalytically active substance. For this purpose, an insulation layer, for example, may be provided between spacer element 50, 51 and first and second electrodes 31, 32, or the catalytically active material is situated at a distance from first and/or second electrodes 31, 32 in the spacer element.

What is claimed is:

1. A sensor element for determining a gas component, in particular for determining the oxygen concentration in exhaust gases of internal combustion engines, having a measurement gas space (41) which is introduced into the sensor element (10) and in which at least one electrode (31, 32) is provided and which is connected to the gas outside of the sensor element (10) via a gas inlet opening (43), a diffusion barrier (44) being provided between the gas inlet opening (43) and the electrode (31, 32),
wherein at least one spacer element (50) is provided in at least some areas of the measurement gas space (41), this spacer element having a higher pore content than the diffusion barrier (44).

2. The sensor element as recited in claim 1,
wherein the spacer element (50) fills up at least approximately the entire area between a first and a second electrode (31, 32).

3. The sensor element as recited in claim 1 or claim 2,
wherein the spacer element (50) has a pore content (in vol %) which is at least 30% higher than the pore content (in vol %) of the diffusion barrier (44).

4. The sensor element as recited in at least one of the preceding claims,
wherein the spacer element (50) has a pore content of 60 to 85 vol %, preferably 70 vol %.

5. A sensor element for determining a gas component, in particular for determining the oxygen concentration in exhaust gases of internal combustion engines, having a measurement gas space (41) which is introduced into the sensor element (10) and in which at least one electrode (31, 32) is provided and which is connected to the gas outside of the sensor element (10) via a gas inlet opening (43), a diffusion barrier (44) being provided between the gas inlet opening (43) and the electrode (31, 32),
wherein at least one spacer element (51) is provided in some areas of the measurement gas space (41), allowing access of the measurement gas to at least the areas of the electrode (31, 32) not covered by the spacer element (51).

6. The sensor element as recited in claim 5,
wherein the spacer element(s) (51) cover(s) at most 50%, preferably 0 to 30% of the area of the electrode (31, 32).

7. The sensor element as recited in claim 5 or 6,
wherein the spacer element (51) has a closed porosity or no porosity at all.

8. The sensor element as recited in at least one of claims 5 through 7,
wherein the spacer element (51) has a rectangular, triangular, or circular-segmental cross-section.

9. The sensor element as recited in at least one of claims 5 through 8,
wherein the spacer element(s) (51) is/are situated in the measurement gas space (41) in the manner of supporting posts; the spacer elements (51) preferably being situated on the side of the measurement gas space (41) facing away from the diffusion barrier (44); the spacer elements (51) are located uniformly in the measurement gas space (41); and/or four to twelve, preferably eight spacer elements (51) resembling supporting posts are provided.

10. A sensor element for determining a gas component, in particular for determining the oxygen concentration in exhaust gases of internal combustion engines, having a measurement gas space (41) which is incorporated in the sensor element (10) and in which at least one electrode (31, 32) is provided and which is connected to the gas outside of the sensor element (10) via a gas inlet opening (43), a diffusion barrier (44) being provided between the gas inlet opening (43) and the electrode (31, 32) at a distance from the electrode (31, 32),
wherein the magnitude of the diffusion flow of the measurement gas and/or of a component of the measurement gas from the gas inlet opening (43) to the electrode (31, 32) is limited essentially by the diffusion barrier (44).

11. The sensor element as recited in at least one of the preceding claims,
wherein a second electrode (32) is provided in the measurement gas space (41) and is situated on a side of the measurement gas space (41) directly opposite a first electrode (31).

12. The sensor element as recited in at least one of the preceding claims,
wherein the spacer element (50, 51) has a material that insulates with respect to electron conduction.

13. The sensor element as recited in at least one of the preceding claims,
wherein the spacer element (50, 51) has Al₂O₃ and/or ZrO₂.

14. The sensor element as recited in at least one of the preceding claims,
wherein the spacer element (50, 51) contains a catalytically active material.

15. The sensor element as recited in claim 14,
wherein the catalytically active material is electron-conducting and contains platinum, for example, and the catalytically active material is situated at a distance from the first and/or second electrode (31, 32) in or on the spacer element (50, 51).

16. A method of manufacturing a sensor element as recited in claims 1, 5 or 10,
wherein the spacer element (50, 51) is formed by a paste which contains a ceramic material and a pore-forming substance before a sintering operation, the average particle radius of the ceramic powder and the pore-forming substance differing by no more than 20%.

17. The method as recited in claim 16,
wherein the amount by volume of ceramic material in the paste in the unsintered state amounts to 20 to 40 vol %, preferably 30 vol %.

18. The method as recited in claim 16 or 17,
wherein the pore-forming substance contains glass carbon, theobromine, flame carbon, and/or other carbon compounds.

19. The method as recited in claims 16 through 18,
wherein the amount by volume of the ceramic material and the amount by volume of the pore-forming substance in the paste in the unsintered state differ by no more than 20%.

20. The method as recited in claims 16 through 19,
wherein the average particle diameter of the ceramic powder and/or the pore-forming substance is in the range of 2 to 30 μm, preferably 10 μm.
